(19) United States
(12) Patent Application Publication
(10) Pub. No.: US 2026/0008379 A1
(43) Pub. Date: Jan. 8, 2026

(54) METHODS AND SYSTEMS FOR ENABLING MANAGEMENT OF ELECTRIC VEHICLE CHARGERS FROM MULTIPLE CHARGE POINT MANAGEMENT SYSTEMS

(71) Applicant: BluWave Inc., Ottawa (CA)

(72) Inventors: Lutz TISCHENDORF, Gatineau (CA); Thomas TRIPLET, Ottawa (CA)

(21) Appl. No.: 18/764,263

(22) Filed: Jul. 4, 2024

(51) Int. Cl. B60L 53/68; B60L 53/62; H04L 45/24

(52) U.S. Cl. CPC B60L 53/68; B60L 53/62; H04L 45/24

(57) ABSTRACT

Improvements in EV charging system communications technologies are provided. An Open Charge Point Protocol (OCPP) router is provided enabling an EV charge point (CP) to communicate with multiple charge point management systems (CPMSs). Separate connections are established between the CP and the router, and between the CP and each of multiple CPMSs. The router routes messages between the CP and the CPMSs based on stored routing information, which comprises information relating to point to point communication paths between the CP and each of the CPMSs. The OCPP router enables a CP to communicate with, and to be controlled by, multiple CPMSs, which may allow for expanded functionalities, increased flexibilities, and new uses.

### FIELD

The present disclosure relates to electric vehicle (EV) charging systems, and more particularly to communications in EV charging systems.

### BACKGROUND

The electrification of transportation via EVs, for example battery EVs (BEVs) and plugin hybrid EVs (PHEVs) requires EV chargers or charge points (CPs), which transfer energy from a source, for example a grid, microgrid, a generator, another battery, another EV, and so on, to a charge controller of an EV in order to recharge the battery of the EV. EV chargers are therefore a key part of the infrastructure needed to enable electric transportation via EVs.

EV chargers can be generally divided into two categories. A first category is chargers for which no remote management of the charger is possible. These chargers are generally referred to as basic EV chargers. A second category is chargers for which remote management of the charger is possible. Remote management may be done via a central management system such as a charge point management system (CPMS), which is sometimes called a charging station management system (CSMS). These chargers are generally referred to as smart EV chargers.

The management of smart EV chargers via CPMS may include one or more of the following example operations: monitoring of the operational status; authorization of charging sessions; retrieving meter values, such as current power consumption, delivered energy, voltage etc.; controlling power supply to EV; firmware updates; enable user facing mobile applications to control and monitor charging sessions; and configuration management.

In order to manage EV chargers via a CPMS, each EV charger may be communicatively coupled with a CPMS, for example via a communication link, connection, or network, for example a Local Area Network (LAN) or the Internet.

### BRIEF DESCRIPTION OF DRAWINGS

Example embodiments of the present disclosure will now be described with reference to the attached Figures.

FIG. 1 is a diagram showing a limitation of an Open Charge Point Protocol (OCPP) of a charge point only being able to communicate with a single CPMS.

FIG. 2 illustrates a limitation of OCPP of only enabling a CP to communicate with a single CPMS.

FIG. 3 is a diagram showing an example system and scenario in which an OCPP router according to the present disclosure enables CPs to each communicate with multiple CPMSs.

FIG. 4 is a diagram showing another example system and scenario with three CPs and four CPMSs in which an OCPP router enables the CPs to each communicate with multiple CPMSs.

FIG. 5 is a diagram showing another example system illustrating an example way in which OCPP routers may be connected in a hierarchical manner.

FIG. 6 is a diagram showing another example system illustrating another example way in which OCPP routers may be connected in a hierarchical manner.

FIG. 7 is a block diagram showing some example parts and features of an example sub router.

FIG. 8 shows an unambiguous CP initiated charging session.

FIG. 9 shows an ambiguous CP initiated charging session.

FIG. 10 shows an unambiguous CP initiated charging session.

FIG. 11 shows an unambiguous remotely initiated charging session.

FIG. 12 shows an unambiguous CP initiated messaging.

FIG. 13 shows unambiguous CPMS initiated messaging.

FIG. 14 is a process flow diagram showing some example operation or steps of a computer-implemented method, for example to enable a CP to communicate with multiple CPMSs.

FIG. 15 is a block diagram of an example computerized device or system that may be used in implementing one or more aspects or components of an embodiment.

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

### DETAILED DESCRIPTION

The present disclosure is generally directed to improvements in EV charging system communication technologies and EV charging management technologies. The present disclosure is also directed to improvements in computer-based devices, systems, and methods.

According to an aspect, the present disclosure is directed to improved devices, systems, and methods which have intelligent communications routing capabilities. In at least some embodiments, the intelligent communications routing capabilities enable, among other things, EV chargers to each communicate with multiple CPMSs. This may enable an EV charger to communicate with, and to be managed or controlled by, multiple CPMSs, which may allow for expanded functionalities, increased flexibilities, shared responsibilities, new uses, and so on, in EV management and related technologies.

According to an aspect, the present disclosure is directed to improvements in EV charging systems communications, including communications based on or using the Open Charge Point Protocol (OCPP). The OCPP is a protocol that enables management and communication of EV charging infrastructure, including communications between EV chargers and a CPMS.

According to an aspect, the present disclosure is directed to a system, comprising a computer-readable storage medium having executable instructions; and one or more computer processors configured to execute the instructions to enable a charge point (CP) to communicate with multiple charge point management systems (CPMSs) using an open charge point protocol (OCPP), the instructions to: establish an OCPP connection between an OCPP router and a CP; establish an OCPP connection between the OCPP router and a first CPMS; establish an OCPP connection between the OCPP router and a second CPMS; and route OCPP messages, by the OCPP router, between the CP and the first CPMS and between the CP and the second CPMS, wherein the routing of OCPP messages is based on stored routing information, the routing information comprising information relating to point to point communication paths between the CP and each of the first and second CPMSs.

In an embodiment, the routing information comprises information relating to an origin or a destination of an OCPP message, wherein the information relating to an origin or a destination is derived from an association between the OCPP message and information relating to the websocket transport layer underlying an OCPP connection over which the OCPP message was communicated.

In an embodiment, the routing information comprises information associating at least one of an OCPP message identifier of an OCPP message, an OCPP transaction identifier of an OCPP message, and an OCPP identification tag of an OCPP message, with an origin of the OCPP message.

In an embodiment, the routing information comprises predefined OCPP message sequencing information according to the OCPP.

In an embodiment, the instructions are further to route OCPP messages between the CP and the first CPMS to initiate an EV charging session at the CP; and route OCPP messages between the CP and the second CPMS to configure electrical charging parameters for the EV charging session.

In an embodiment, the routing OCPP messages comprises receive an OCPP message with identification tag information from the CP at the OCPP router; in response to the routing information not having an association between the identification tag information and one of the first and second CPMSs, routing the OCPP message to both the first and second CPMSs; receive authentication messages from both the first and second CPMSs in relation to the identification tag information; in response to receiving the authentication messages from both the first and second CPMSs, sending rejection messages to the CP and the first and second CPMSs.

In an embodiment, the instructions are further to route OCPP messages, by the OCPP router, between a second CP and each of multiple CPMSs over OCPP connections between the second CP and the OCPP router and between the OCPP router and each of the multiple CPMSs.

According to an aspect, the present disclosure is directed to a method comprising at one or more electronic devices having one or more computer processors and computer-readable memory, for enabling a charge point (CP) to communicate with multiple charge point management systems (CPMSs) using an open charge point protocol (OCPP): establishing an OCPP connection between an OCPP router and a CP; establishing an OCPP connection between the OCPP router and a first CPMS; establishing an OCPP connection between the OCPP router and a second CPMS; and routing OCPP messages, by the OCPP router, between the CP and the first CPMS and between the CP and the second CPMS, wherein the routing of OCPP messages is based on stored routing information, the routing information comprising information relating to point to point communication paths between the CP and each of the first and second CPMSs.

In an embodiment, the routing information comprises information relating to an origin or a destination of an OCPP message, wherein the information relating to an origin or a destination is derived from an association between the OCPP message and information relating to the websocket transport layer underlying an OCPP connection over which the OCPP message was communicated.

In an embodiment, the routing information comprises information associating at least one of an OCPP message identifier of an OCPP message, an OCPP transaction identifier of an OCPP message, and an OCPP identification tag of an OCPP message, with an origin of the OCPP message.

In an embodiment, the routing information comprises predefined OCPP message sequencing information according to the OCPP.

In an embodiment, the method further comprises routing OCPP messages between the CP and the first CPMS to initiate an EV charging session at the CP; and routing OCPP messages between the CP and the second CPMS to configure electrical charging parameters for the EV charging session.

In an embodiment, the routing OCPP messages comprises receiving an OCPP message with identification tag information from the CP at the OCPP router; in response to the routing information not having an association between the identification tag information and one of the first and second CPMSs, routing the OCPP message to both the first and second CPMSs; receiving authentication messages from both the first and second CPMSs in relation to the identification tag information; in response to receiving the authentication messages from both the first and second CPMSs, sending rejection messages to the CP and the first and second CPMSs.

In an embodiment, the method further comprises routing OCPP messages, by the OCPP router, between a second CP and each of multiple CPMSs over OCPP connections between the second CP and the OCPP router and between the OCPP router and each of the multiple CPMSs.

According to an aspect, the present disclosure is directed to a non-transitory computer-readable medium comprising computer-readable instructions stored on the computer-readable medium, the instructions for enabling a charge point (CP) to communicate with multiple charge point management systems (CPMSs) using an open charge point protocol (OCPP), the computer-readable instructions to executable by at least one processor to cause the performance of operations comprising: establishing an OCPP connection between an OCPP router and a CP; establishing an OCPP connection between the OCPP router and a first CPMS; establishing an OCPP connection between the OCPP router and a second CPMS; and routing OCPP messages, by the OCPP router, between the CP and the first CPMS and between the CP and the second CPMS, wherein the routing of OCPP messages is based on stored routing information, the routing information comprising information relating to point to point communication paths between the CP and each of the first and second CPMSs.

In an embodiment, the routing information comprises information relating to an origin or a destination of an OCPP message, wherein the information relating to an origin or a destination is derived from an association between the OCPP message and information relating to the websocket transport layer underlying an OCPP connection over which the OCPP message was communicated.

In an embodiment, the routing information comprises information associating at least one of an OCPP message identifier of an OCPP message, an OCPP transaction identifier of an OCPP message, and an OCPP identification tag of an OCPP message, with an origin of the OCPP message.

In an embodiment, the routing information comprises predefined OCPP message sequencing information according to the OCPP.

In an embodiment, the operations further comprise routing OCPP messages between the CP and the first CPMS to initiate an EV charging session at the CP; and routing OCPP messages between the CP and the second CPMS to configure electrical charging parameters for the EV charging session.

In an embodiment, the operations further comprise routing OCPP messages, by the OCPP router, between a second CP and each of multiple CPMSs over OCPP connections between the second CP and the OCPP router and between the OCPP router and each of the multiple CPMSs.

OCPP was defined as a stateless message exchange format over an exclusive point-to-point transportation layer in the form of Websockets (RFC 6455). Websockets allow for bidirectional communication between two connected endpoints over the internet and provide a fixed predefined communication channel over which messages can be sent in both directions. Such a connection may be referred to as an OCPP connection. Because the communication channel is fixed and unchangeable, the messages themselves between the charger and the CPMS do not have to contain any information about their origin or destination. OCPP messages are therefore unaware of their destination, which is defined by the endpoint of the underlying point-to-point communication layer. The OCPP is therefore inherently dependent on a point-to-point transportation layer and used exclusively over Websocket connections.

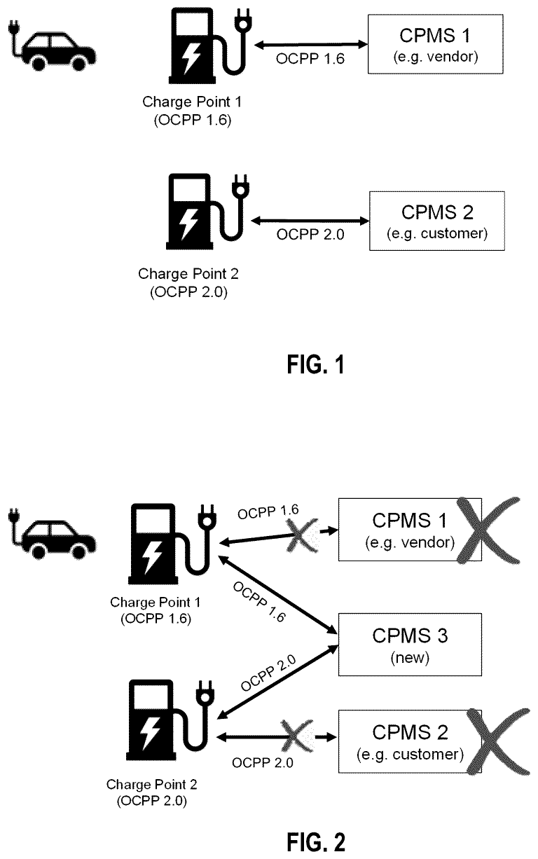

FIG. 1 shows a point-to-point communication between single EV chargers, herein referred to as charge points (CPs), and single CMPSs. The point-to-point transportation of messages binds two endpoints exclusively to each other without any possibility of routing those messages to any other endpoint. Therefore, any kind of message routing in support of load balancing or failover handling is generally not possible. Furthermore, since each CP can only receive operational instructions via OCPP from one single CPMS, all operational aspects are generally covered by that one CPMS. Sharing operational responsibilities among multiple CPMSs, such as transaction authorization or power management or status and meter monitoring, is typically not possible. It is noted that the labels in the figures of the present disclosure referencing various versions of the OCPP, for example OCPP 1.6 and OCPP 2.0, are only examples and are thus not limiting in any way.

For instance, EV chargers are often pre-configured by the manufacturers to communicate with the CPMS of the manufacturer. As the OCPP protocol does not allow for communications between a CP and multiple CPMSs, the EV charger owner may have to replace the CPMS of the manufacturer to use another CPMS, potentially foregoing some of the original functionalities of the CP.

The present disclosure generally applies to all versions of the OCPP. In addition, the present disclosure generally applies to all smart EV chargers regardless of current type (AC or DC chargers) and power supply levels, including Level 1 (AC 100-120V, around 1 KW), Level 2 (AC 200-240V, up to 22 kW), and Level 3 (DC 400-800V).

As noted above, the OCPP has some limitations, including only allowing an EV charger to communicate with a single CPMS.

FIG. 2 illustrates a limitation of OCPP of only enabling a CP to communicate with a single CPMS. In the example, Charge Point 1 was previously connected to CPMS 1. To communicate with a different CPMS 3, its communication with CPMS 1 first has to be terminated, which is indicated by the ‘X’s in the figure. Then, Charge Point 1 can begin to communicate with CPMS 3. The same is shown for Charge Point 2 in relation to CPMS 2 and CPMS 3.

Thus, a CP can communicate with a single CPMS at a time. If the CPMS destination can be configured in a CP, the CP can then be instructed to communicate with another CPMS at another time. While this is technically possible, it does not include simultaneous communication between multiple CPMS.

These inherent limitations of OCPP hinder shared operational responsibilities and collaborative innovation, making it difficult to standardize routine operations, such as monitoring and testing, as well as the integration of more advanced capabilities, including grid-aware demand-response power management and optimization.

There are several possible uses or benefits to having an EV charger able to communicate with multiple CPMS, including simultaneously or alternatingly.

One possible use is for shared operational and/or monitoring responsibilities. Operational responsibilities may refer to managing and controlling a CP, which may include, for example, any or all parts of a charging session, such as authentication, starting of the session, electrical parameter of the session such as power or current levels, termination of the session, CP maintenance, CP upgrades such as firmware, and so on. Monitoring responsibilities may refer to metering at the CP, obtaining status or other operational parameters or information relating to the CP, and so on.

Another possible use is adding intelligent load or power management, for example based on artificial intelligence (AI) or machine learning (ML), or in response to demand response events, to an existing CPMS without interfering with the ongoing operations of that CPMS. For example, consider a fleet operator, who uses a CPMS to manage charging session authorization and EV charger provisioning on premise. Their infrastructure does not have access or means to receive and respond to signals from the outside world, such as anticipated load peaks or energy price fluctuations or power capacity constraints. A second CPMS, which may have access to such information may be used to manage those power related operational aspects simultaneously to the operational aspects covered by the primary CPMS.

Another possible use is for independent status and/or meter monitoring of EV chargers. For example, continuous status monitoring of EV chargers combined with notification and escalation processes are often needed for providing highly available and reliable EV chargers to EV drivers. While such monitoring systems may exist, they are often difficult to implement in a standardized way within a single CPMS. Therefore, a second CPMS may be used to retrieve status and meter OCPP messages from EV chargers and process and forward those messages to established backends.

Another possible use is a systematic automated testing of OCPP operations. For example, as modern hardware, EV chargers included, is subject to rather frequent firmware updates, there comes a risk with each firmware update that OCPP related operations change their expected behavior or bear bugs, which may affect the operational capabilities of the EV charger. Such changes can lead to unexpected behavior or malfunction, which could be detected by a systematic test of all OCPP operations after each firmware update. Most primary CPMS do not allow for or integrate such test protocols in their operational envelope, another reason why a second CPMS could fulfill this task without interrupting the operations of the primary CPMS.

Another possible use or benefit is that shared responsibility and transparency may create trust and facilitate innovation. For example, innovation can be hampered by exclusive control and communication structures, in particular when expensive assets are involved. In the realm of EV chargers, OCPP does not facilitate collaboration and mutual control. For example, consider an AI company wanting to test their load optimizer on an EV charging infrastructure of a customer. Currently, there are seemingly two options. A first option is for the customer to hand over the entire control of its EV chargers to the AI company while at the same time losing visibility and control of all his EV chargers. At the same time, the AI company may not be in a position to maintain operational control of the EV charges entrusted to it. A second option is for the customer to build extra software and adopt his primary CPMS to be able to integrate the AI companies' load optimization into its primary operations. Either solution is not practical and not adequate in live operations of a charger network and/or chargers for a fleet of EVs. If there was a way to add intelligent load optimization by means of letting a second CPMS communicate with the customers EV chargers, the chances for a successful collaboration would be much higher.

As noted above, according to an aspect, the present disclosure is directed to improved devices, systems, and methods having intelligent routing capabilities, which enable CPs to each communicate with multiple CPMSs. The present disclosure overcomes a primary design limitation of the OCPP, namely the exclusive point-to-point relationship between an EV charger and its CPMS. The limitation may be overcome without impacting or conflicting with the OCPP standard itself. In an embodiment, the devices and systems according to the present disclosure are transparent to the CP and the CPMS. The devices and systems may seamlessly enable communications between a CP and multiple CPMSs, thereby unleashing potential uses or benefits including those mentioned above. The communication between a CP and multiple CPMSs may be done simultaneously or alternatingly, and may be done without having to repeatedly establish and tear down communication channels between a CP and each of the CPMSs.

According to an aspect, the present disclosure provides an intelligent message router, which in at least some embodiments may be referred to as an OCPP router, for routing communications between EV CPs and one or multiple CPMS. An OCPP router may act as a CPMS between CPs and one or multiple CPMS.

An OCPP router may establish a point-to-point connection between the CP and itself, and one or multiple point-to-point connections between itself and each of the one or more CPMSs. These connections may be OCPP connections. The OCPP router may route OCPP messages between the CP and each of the CPMSs based on stored routing information, which may include information relating to point to point communication paths between the CP and each of the CPMSs. In addition, routing information may include any suitable information relating to, and/or associations between, CPs, CPMS, OCPP or other messages, users, sources, destinations, unique message identifiers, transaction identifiers, identification tags, or any other entities or information.

An OCPP router may be transparent to the CP and the CPMS(s) and may intercept the transport of OCPP messages between a CP and a CPMS. Interception means that the OCPP router receives, reads and interprets the OCPP message, matches information contained in the OCPP message against stored information from previous OCPP messages and uses the outcome to decide where to route the OCPP message. An OCPP router may inspect and analyze the content of an OCPP message, for example to identify if the OCPP message is a CALL or CALLBACK message or if the OCPP message is the response to a previous TriggerMessage. In addition, the OCPP router may store any suitable information relating to an intercepted message, such as charging session/transaction or message identifiers and their associated CPMS. The information may relate to a target endpoint, which may be a CPMS or CP. An OCPP router may send an OCPP message to one or more endpoints via the one or more corresponding point-to-point communication channels. See for example FIG. 9, where the OCPP router sends a “RejectStartTransaction” message to the ChargePoint and CPMS1 and CPMS 2 after having identified an ambiguous situation in that CPMS1 and CPMS2 both authorized the requested charging session, which violates the concept of a single transaction per charging session.

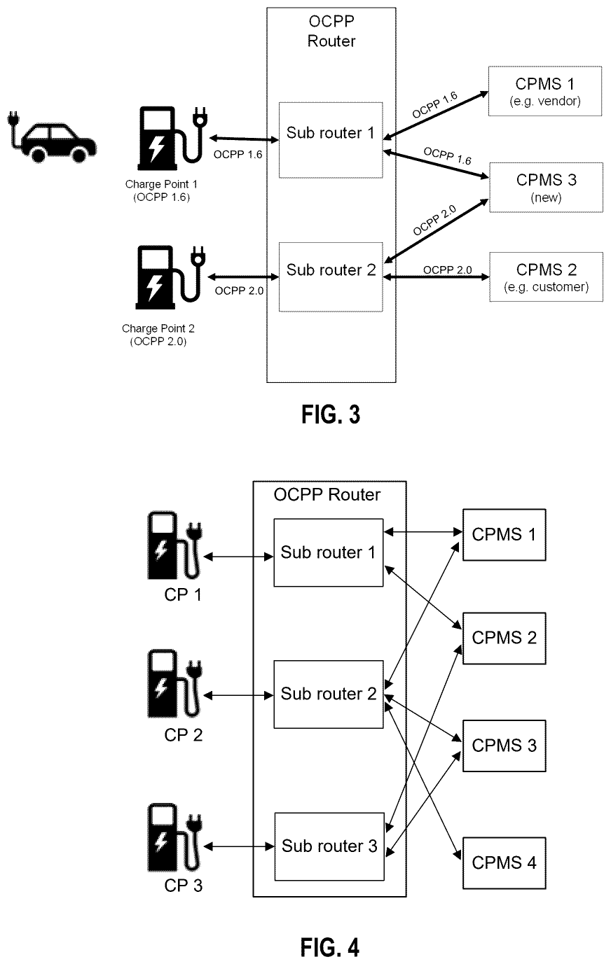

FIG. 3 is a diagram showing an example system and scenario in which an OCPP router according to the present disclosure enables CPs to each communicate with multiple CPMSs. There is a communication path between a CP and the OCPP router, and there are communication paths between the OCPP router and each of the CPMSs. In this embodiment, the OCPP router comprises multiple sub routers. A sub router may be associated with, and thus communicate with, a specific CP as shown in this example. For example, sub router 1 is associated with CP 1, while sub router 2 is associated with CP 2. In turn, sub router 1 communicates with CPMS 1 and CPMS 2 enabling CP 1 to communicate with both of CPMS 1 and CPMS 2. The same applies for CP 2 in relation to CPMS 2 and CPMS 3.

In another embodiment, an OCPP router may not necessarily have sub routers structured or configured in this way or in a similar way, meaning each associated with a specific CP, or may not have any sub routers at all. In other words, an OCPP router may provide the same or similar functionality without having sub routers configured as shown in FIG. 3 or without having any sub routers at all.

FIG. 4 is a diagram showing another example system and scenario with three CPs and four CPMSs in which an OCPP router enables the CPs to each communicate with multiple CPMSs.

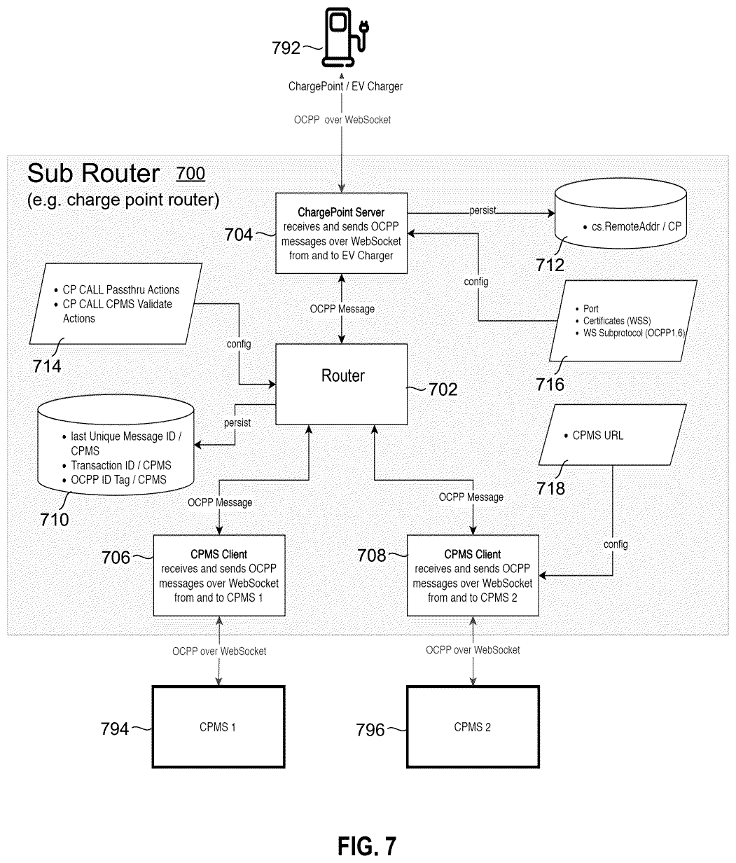

In an embodiment, an OCPP router behaves like a CPMS for an OCPP connection of a CP, and receives all OCPP messages from the CP. The OCPP router appears as a single CP to each connected CPMS and receives all OCPP messages from all connected CPMSs. The OCPP router may store information relating to all point-to-point connections between itself and the CP, and between itself and each of the one or more CPMSs. FIG. 7 provides an example of some example types of information that may be stored.

The OCPP router may identify each OCPP message type, such as CALL, CALLBACK and ERROR messages as defined in the OCPP specification.

The OCPP router may route OCPP messages from a CP to all connected CPMSs or to just one connected CMPS. The OCPP router may route OCPP messages from each connected CPMS to a CP.

An OCPP router may act as a server toward a CP and as a client toward each connected CPMS. The OCPP router may essentially eliminate the “point-to-point” connection between a CP and each CPMS by using intelligent routing logic to identify the destination of each incoming OCPP message. This may be achieved by associating information from the underlying transport layer/WebSocket with the OCPP message content itself and storing this information so that it may be used to identify the destination of future OCPP messages. The OCPP router may analyze each OCPP message and store CPMS specific information based on its knowledge of each OCPP messages origin, which may be derived by associating transport layer information with the OCPP message itself. Transport layer information may relate to a transport layer underlying an OCPP connection over which the OCPP message was communicated.

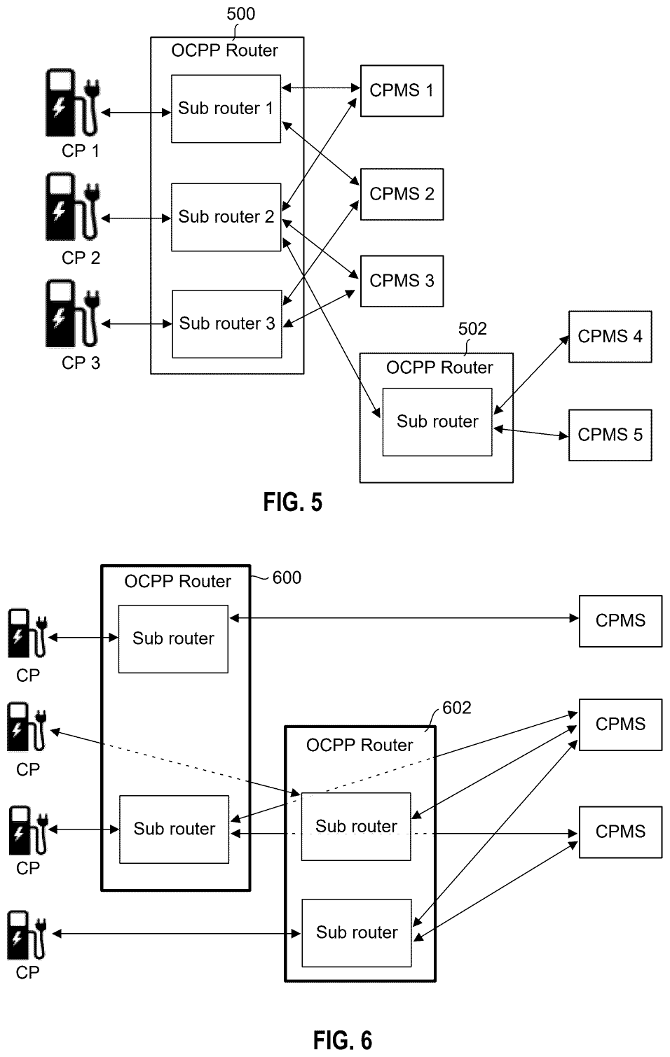

FIG. 5 is a diagram showing another example system illustrating an example way in which OCPP routers may be connected in a hierarchical manner. Here, OCPP router 500 is connected with OCPP router 502. Sub router 2 of OCPP router 500 is connected with the sub router of OCPP router 502, which is connected with CPMS 4 and CPMS 5.

FIG. 6 is a diagram showing another example system illustrating another example way in which OCPP routers may be connected in a hierarchical manner. Here, the system has multiple OCPP routers 600, 602. In this example, OCPP routers 600, 602 are communicatively chained, meaning they may communicate with one another to convey and receive OCPP messages and potentially other information. This example is meant to show that the functionality of an OCPP router according to the present disclosure may be achieved in any suitable way. Use cases for hierarchical OCPP router architectures may arise with the ongoing evolution of charging infrastructure.

According to an aspect, the present improvements leverage and utilize one or more features of the OCPP to enable communications between a CP and multiple CPMSs.

One example feature relates to a websocket connection representing a unique endpoint, a CP or CPMS, for an OCPP router. This information may be used to identify the origin of an incoming OCPP message.

Another example feature relates to unique message identifiers according to OCPP. OCPP is based on a “call-confirm” or “request-response” paradigm and each OCPP message bears a unique message identifier. A CALL message to either a CP or a CPMS is returned by a CALLBACK message where the CALLBACK message bears the same unique message identifier as the initiating CALL message.

Another example feature relates to message sequences according to OCPP. A CALL message precedes a confirmation or CALLBACK message. An OCPP router may therefore store unique message identifiers from CALL messages and associate those identifiers with the origin of that CALL message in order to later route the confirmation message to the origin of the associated CALL message. As noted above, an origin of an OCPP message may be determined based on the fact that a websocket connection representing a unique endpoint.

Another example feature relates to transaction identifiers according to OCPP. Some OCPP messages bear a transaction identifier, which is managed and owned by one CPMS. The OCPP router may therefore store transaction identifiers and associate the transaction identifiers with the origin of the OCPP message in order to later route OCPP messages with the same transaction identifier to the associated origin.

Another example feature relates to OCPP identification tags (ID Tags) according to OCPP. Some OCPP messages bear OCPP ID Tags, which are managed and owned by one CPMS. The OCPP router may therefore store OCPP ID Tags and associate the OCPP ID Tags with the origin of the OCPP message in order to later route OCPP messages with the same OCPP ID Tag to the associated origin.

Accordingly, an OCPP router may use and combine information relating to an origin of an OCPP message, for example via Websocket connection information, unique attributes of an OCPP message, which may be associated with the origin of the message, and information relating to message sequences according to OCPP, in order to intelligently route OCPP messages to the proper destinations.

FIG. 7 is a block diagram showing some example parts and features of an example sub router 700, for example of an OCPP router. In this example, an OCPP router is not illustrated. Sub router 700 may be communicatively coupled with CP 792 and CPMS 1 794 and CPMS 2 796. Furthermore, sub router 700 may comprise a router 702, a CP server 704, CPMS client 706, CPMS client 708 or more CPMS clients, database 710, database 712, configuration information 714, and configuration information 716.

Router 702 may generally include the routing logic and control for routing communications between CP 792 and CPMS1 794 and CPMS2 796 and may generally act as the main processing and control entity of sub router 700. Router 702 may be configured with various configuration information or parameters 714, for example information about action types, some of which may be passed through/broadcasted to all connected CPMS (for example Heartbeat, StatusNotifications, etc.) or actions which may need to be validated before determining the destination, for example StartTransaction messages. Router 702 may cause to be stored, for example in database 710, any suitable information, for example the last unique message ID received from either a CP or a CPMS so as to match the corresponding CALLBACK message to its origin by matching the unique message ID and the associated origin of this message.

CP server 704 may receive and send OCPP messages over an OCPP connection between sub router 700 and a CP 792. CP server 704 may be configured with various configuration information or parameters 716, such as the port number, security certificates for data encryption and the websocket subprotocol information. CP server 704 may cause to be stored, for example in database 712, any suitable information, for example address information of the CP.

CPMS client 708 may receive and send OCPP messages over an OCPP connection between sub router 700 and CPMS2 796. CPMS client 708 may be configured with various configuration information or parameters 718, for example address information such as an address (e.g. uniform resource locator) of a CPMS, which is the websocket URL at which the CPMS is reachable.

CPMS client 706 may generally have the same or similar features and functions a CPMS client 708.

An example of how operational responsibility may be shared between several CPMSs is now provided. A first CPMS may authenticate a request for a charging session at a CP by an EV (or person user associated with the EV who may have requested the charging session). The first CPMS may handle authentication, and starting and termination of the charging session. A second CPMS may provide some control over electrical parameters of the charging during the charging session. The control may involve configuring, for example setting or modifying, at least some of the electrical parameters, which may include charging power, current or voltage, and so on. An OCPP router may route OCPP messages between the CP and the first CPMS to initiate an EV charging session at the CP. The OCPP router may route OCPP messages between the CP and the second CPMS to configure electrical charging parameters for the EV charging session. In this way, operational responsibility for the CP may be shared between multiple CPMSs. This is merely an example to illustrate the concept and application of shared operational responsibility.

In at least some embodiments, an OCPP router may identify ambiguous message situations, meaning situations where a destination of an OCPP message cannot be unambiguously identified by the OCPP router. Further, an OCPP router may resolve ambiguous message situations, for example by interfering with valid OCPP message responses on behalf of a CP or a CPMS.

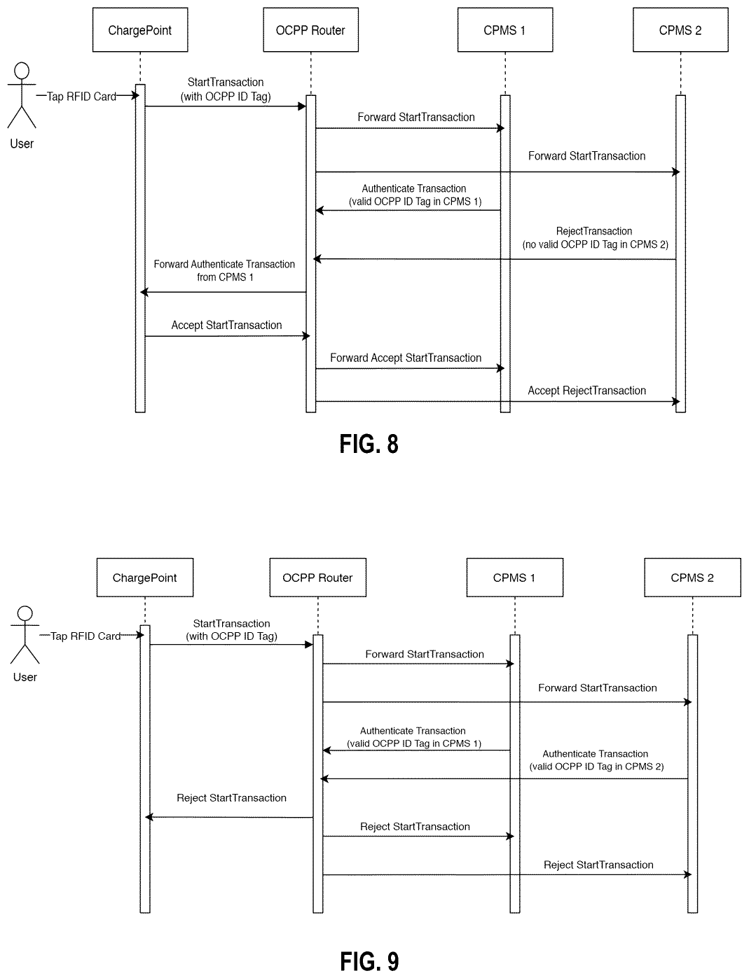

If a destination of an OCPP message cannot be unambiguously identified, the OCPP router may “interfere”, for example by either suppressing or generating OCPP messages toward either the CPMS or the CP so that an operational status remains intact and compliant with the expectations of the OCPP standard. Some examples are provided in FIGS. 8-13, discussed further below.

The following example illustrates ambiguity with regard to a destination of an OCPP message. An EV driver plugs their EV into a CP and authorizes themselves in relation to the CP, for example with a mobile application on a smart phone or by means of an RFID card tapped at the CP. The CP may send a “StartCharging” call OCPP message, which contains an authorization token, which may be called an “OCPP ID Tag”, that is associated with the EV driver and may have been obtained from the EV driver or some device associated with the EV driver. The OCPP ID Tag is managed by the CPMS, but the OCPP router is not yet be aware of this association. Thus, the OCPP router does not know the destination of the OCPP message. Accordingly, the OCPP router routes this “StartCharging” call message to all CPMSs to which it is connected. Each CPMS may then validate the OCPP ID Tag and send a confirmation message back to the OCPP router. The OCPP router now analyzes all received confirmation or CALLBACK messages and makes a decision.

One decision is to forward a confirmation or CALLBACK message to the CP if only one CPMS accepted and authorized the “StartCharging” CALL message. If only one CPMS accepted, then presumably that CPMS is the destination of the “StartCharging” CALL message. The OCPP router may then store an association of the OCPP ID Tag with the originating CPMS of that confirmation message.

Another decision is for the OCPP router to create and send a “Reject” confirmation message to the CP on behalf of all the CPMSs. This may be done if two or more CPMSs accepted the “StartCharging” request. This may be considered an ambiguous situation since the OCPP ID Tag is known and valid to more than one CPMS. Further, the OCPP router may create and send a “Reject” confirmation message to the CP on behalf of all the CPMSs if all confirmation messages received back from the CPMSs rejected the “StartCharging” request. This may be considered an ambiguous situation since the OCPP ID Tag is unknown to all the CPMSs. Thus, the OCPP router may thus prevent the EV charger from charging at the CP.

Likewise, a confirmation or CALLBACK OCPP message sent to a CPMS must have been preceded by a CALL message from the CPMS. If a CPMS receives a rogue confirmation message with a unique message identifier for which no CALL message has been issued, then the CPMS will disconnect the OCPP connection with the OCPP router. Therefore, the OCPP may be configured to keep track of OCPP messages and their unique message identifiers, and possibly the message arrival times, in an attempt to prevent such situations.

FIGS. 8-13 are diagrams showing example message sequences or flows of various unambiguous and ambiguous messaging situations.

FIG. 8 shows an unambiguous CP initiated charging session, for example initiated via an RFID tag tap or other input at the CP or via some other authentication at or in relation to the CP. An OCPP ID tag associated with the EV driver (or other person initiating the charging session) is obtained during the initiation, and is authenticated by only one of multiple connected CPMSs. Since only one of the CPMSs, namely CPMS1, authenticated the transaction, the OCPP sends an authentication message to the CP. The CP accepts the authentication and notifies the OCPP router, which in turn notifies CPMS1. The CP may start the charging session.

FIG. 9 shows an ambiguous CP initiated charging session. An OCPP ID tag associated with the EV driver is obtained during the initiation, and is authenticated by multiple connected CPMSs. Since more than one CPMSs authenticated the transaction, the OCPP sends a rejection message to the CP and the CP does not start a charging session. The OCPP router may send reject messages to the CPMSs.

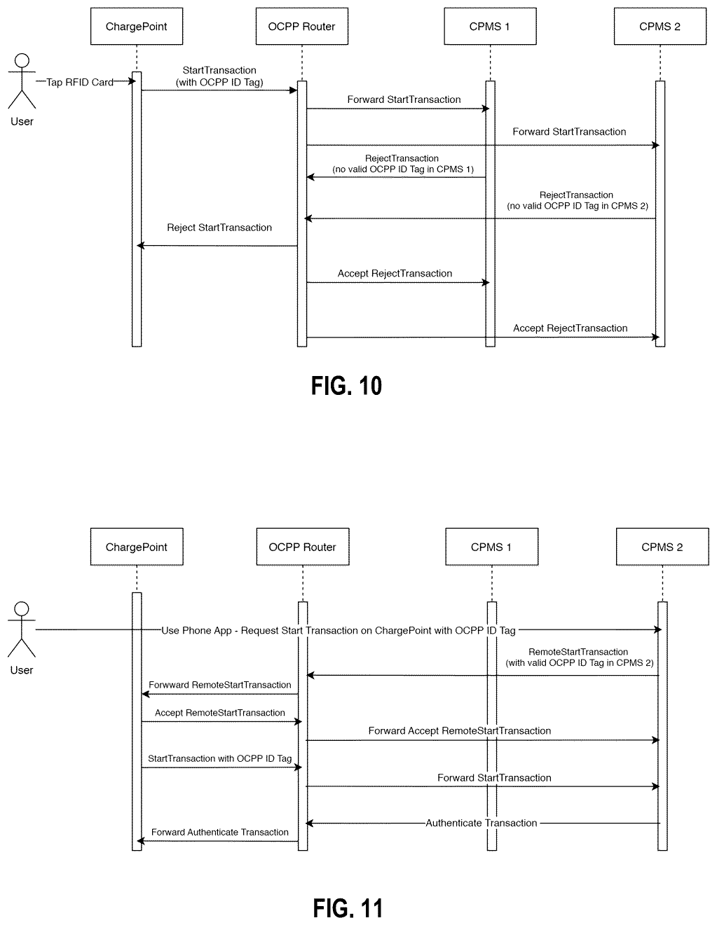

FIG. 10 shows an unambiguous CP initiated charging session. An OCPP ID tag associated with the EV driver is obtained during the initiation, and is not authenticated by any of the connected CPMSs. The OCPP sends a rejection message to the CP and the CP does not start a charging session.

FIG. 11 shows an unambiguous remotely initiated charging session, for example initiated via a computing device associated with the EV driver, such as a phone application on a smart phone. An OCPP ID tag associated with the EV driver is obtained during the initiation, and may be provided by the relevant CPMS (here CPMS2) to the OCPP router along with a remoteStartTransaction request. The OCPP may forward the request to the CP, which accepts. The OCPP then notifies CPMS2 of the acceptance with a StartTransaction message, and CPMS2 authenticates the transaction. The OCPP then forwards an authentication to the CP and the CP may start the charging session.

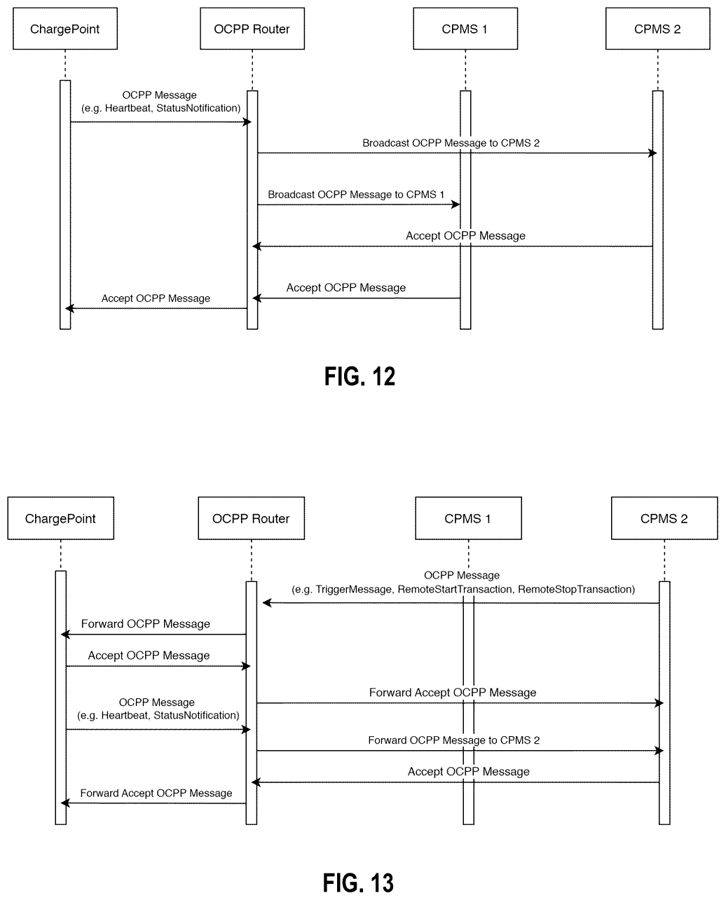

FIG. 12 shows an example of unambiguous CP initiated messaging. The CP may send one or more OCPP messages to the OCPP router, for example a heartbeat message (for example to indicate presence, normal operation, and so on) or a status notification message (to signify some status information). The OCPP router may send the OCPP message to the CPMSs, for example as a broadcast message. Since only one CPMS responds to the OCPP router, the OCPP router sends an accept message to the CP.

FIG. 13 shows unambiguous CPMS initiated messaging where the original message may be, for example, a TriggerMessage, a RemoteStartTransaction, or

RemoteStopTransaction, which are defined in the OCPP specification. CPMS2 may send an OCPP message to the OCPP router, which may forward the message to the CP. The CP may accept, and the OCPP may forward the acceptance to CPMS2. The OCPP router may receive a message from the CP, for example a heartbeat message or a status notification message. The OCPP router may forward the message to CPMS2, and CPMS2 may accept. The OCPP router may then forward the acceptance to the CP. Some examples are provided in FIGS. 8-13, discussed further below.

In general, the OCPP router may store information that it receives or determines based on received messages or other information. For example, the OCPP router may store information that it learns about, or associations between, CPs, CPMS, OCPP or other messages, users, sources, destinations, unique message identifiers, transaction identifiers, OCPP ID tags, or any other entities or information. The OCPP may use any of this stored information to route messages in the future. Again, this information may be referred to as routing information. Routing information may include information associating at least one of an

OCPP message identifier of an OCPP message, an OCPP transaction identifier of an OCPP message, and an OCPP identification tag of an OCPP message, with an origin of the OCPP message. Furthermore, routing information may include information relating to predefined OCPP message sequencing information according to the OCPP, some example of which were mentioned above.

Again, the present disclosure is generally directed to improvements in EV charging system communications technologies and EV charging management technologies, including to communications based on or using the Open Charge Point Protocol (OCPP). These improvements may address some significant challenges in the adoption and efficient utilization of the OCPP standard. For example, the present improvements may facilitate shared operational responsibilities, may support and encourage the development of OCPP monitoring and testing standards independent and outside of operational CPMSs, or may encourage collaboration and foster innovation. Furthermore, the present improvements may provide a central configuration mechanism for managing CPMSs since OCPP configuration changes to a CP may typically require physical proximity to the CP, for example Bluetooth or Wi-Fi proximity. Therefore, such configuration changes may need to be performed locally at the CP. However, according to the present disclosure, once a CP is connected to an OCPP router, such configuration changes may be provisioned remotely. Furthermore, the present improvements may provide infrastructure for OCPP failover routing, for example in a case where a CPMS is not available. As such, an OCPP router may provide additional fault tolerance or failover balancing in keeping a CP connected to one CPMS when the connection to another connected CPMS fails or the other CPMS becomes unavailable.

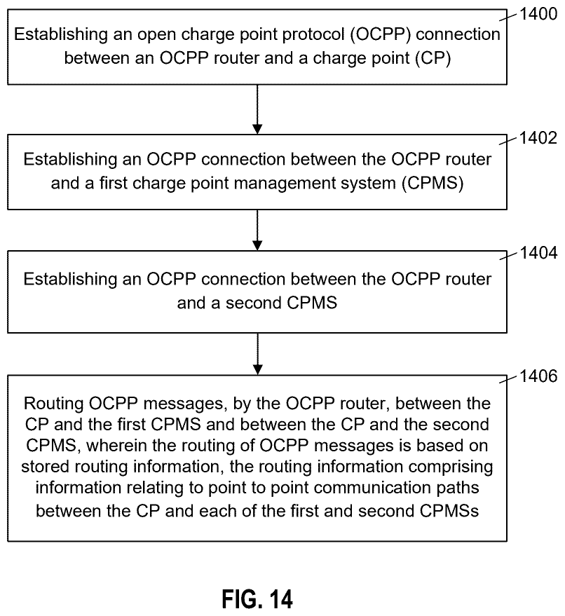

FIG. 14 is a process flow diagram showing some example operation or steps of a computer-implemented method, for example to enable a CP to communicate with multiple CPMSs.

At block 1400, the process may comprise establishing an OCPP connection between an OCPP router and a CP.

At block 1402, the process may comprise establishing an OCPP connection between the OCPP router and a first CPMS.

At block 1404, the process may comprise establishing an OCPP connection between the OCPP router and a second CPMS.

At block 1406, the process may comprise routing OCPP messages, by the OCPP router, between the CP and the first CPMS and between the CP and the second CPMS. The routing of OCPP messages may be based on stored routing information, the routing information comprising information relating to point to point communication paths between the CP and each of the first and second CPMSs.

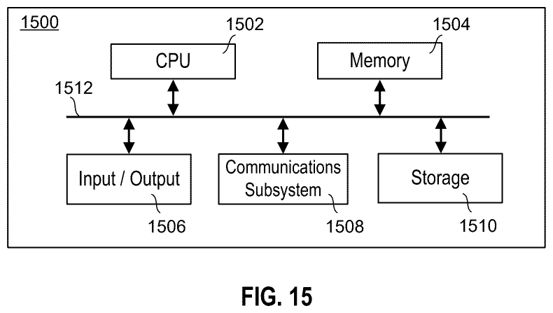

FIG. 15 is a block diagram of an example computerized device or system 1500 that may be used in implementing one or more aspects or components of an embodiment according to the present disclosure. For example, system 1500 may be used to implement a computing device or system, for example a message routing system, a message router, an OCPP router, a sub router, and so on. Thus, one or more systems 1500 may be configured to implement one or more portions of the systems or apparatuses or methods according to the present disclosure.

Computerized system 1500 may comprise one or more of classic, analog, electronic, digital, and quantum computing technologies. Computerized system 1500 may include one or more of a computer processor device 1502, memory 1504, a mass storage device 1510, an input/output (I/O) interface 1506, and a communications subsystem 1508. A computer processor device may be any suitable device(s), and encompasses various devices, systems, and apparatus for processing data and instructions. These include, as examples only, one or more of a hardware processor, a digital processor, an electronic processor, a quantum processor, a programmable processor, a computer, a system on a chip, and special purpose logic circuitry such as an ASIC (application-specific integrated circuit) and/or FPGA (field programmable gate array). In addition, system 1500 may include hardware dedicated to one or more specific purposes, such as a graphics processing unit (GPU), or a tensor processing unit (TPU) or other artificial intelligence accelerator ASIC, for example for machine learning (ML).

Memory 1504 may be configured to store computer readable instructions, that when executed by processor 1502, cause the performance of operations, including operations in accordance with the present disclosure.

One or more of the components or subsystems of computerized system 1500 may be interconnected by way of one or more buses 1512 or in any other suitable manner.

The bus 1512 may be one or more of any type of several bus architectures including a memory bus, storage bus, memory controller bus, peripheral bus, or the like. The processor 1502 may comprise any type of electronic data processor. The memory 1504 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The storage device 1510 may comprise any type of storage device configured to store data, programs, and other information and to make the data, programs, and other information accessible via the bus 1512. The storage device may be adapted to store one or more databases and/or data repositories, each of which is generally an organized collection of data or other information stored and accessed electronically via a computer. The term database or repository may thus refer to a storage device comprising a database. The mass storage device 1510 may comprise one or more of a solid state drive, hard disk drive, a magnetic disk drive, an optical disk drive, or the like. In some embodiments, data, programs, or other information may be stored remotely, for example in the cloud. Computerized system 1500 may send or receive information to the remote storage in any suitable way, including via communications subsystem 1508 over a network or other data communication medium.

The I/O interface 1506 may provide interfaces for enabling wired and/or wireless communications between computerized system 1500 and one or more other devices or systems. Furthermore, additional or fewer interfaces may be utilized. For example, one or more serial interfaces such as Universal Serial Bus (USB) (not shown) may be provided. Further, system 1500 may comprise or be communicatively connectable to a display device, and/or speaker device, a microphone device, an input device such as a keyboard, button, pointer, mouse, touch screen display, microphone, camera, scanner, or any other type of input device.

Computerized system 1500 may be used to configure, operate, control, monitor, sense, and/or adjust devices, systems, and/or methods according to the present disclosure.

A communications subsystem 1508 may be provided for one or both of transmitting and receiving signals over any form or medium of digital data communication, including a communication network. Examples of communication networks include a local area network (LAN), a wide area network (WAN), telecommunications network, cellular network, an inter-network such as the Internet, and peer-to-peer networks such as ad hoc peer-to-peer networks. Communications subsystem 1508 may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1394), Thunderbolt™, Wi-Fi™ (e.g. IEEE 802.11), WiMAX (e.g. IEEE 802.16), Bluetooth™, or Near-field communications (NFC), as well as General Packet Radio Service (GPRS), Universal Mobile Telecommunications System (UMTS), Long-Term Evolution (LTE), LTE-A, 5G NR (New Radio), satellite communication protocols, and dedicated short range communication (DSRC). Communication subsystem 1508 may include one or more ports or other components (not shown) for one or more wired connections. Additionally or alternatively, communication subsystem 1508 may include one or more transmitters, receivers, and/or antenna elements (none of which are shown). Further, system 1500 may comprise clients and servers.

Computerized system 1500 of FIG. 15 is merely an example and is not meant to be limiting. Various embodiments may utilize some or all of the components shown or described. Some embodiments may use other components not shown or described but known to persons skilled in the art.

Logical operations of the various embodiments according to the present disclosure may be implemented as (i) a sequence of computer implemented steps, procedures, or operations running on a programmable circuit in a computer, (ii) a sequence of computer implemented operations, procedures, or steps running on a specific-use programmable circuit; and/or (iii) interconnected machine modules or program engines within the programmable circuits. The computerized device or system 1500 of FIG. 15 may practice all or part of the recited methods or operations, may be a part of systems according to the present disclosure, and/or may operate according to instructions in computer-readable storage media. Such logical operations may be implemented as modules configured to control a computer processor, such as processor 1502, to perform particular functions according to the programming of the module. In other words, a computer processor, such as processor 1502, may execute the instructions, steps, or operations according to the present disclosure, including of the one or more of the blocks or modules. For example, one or more of the modules or blocks or operations and so on according to the present disclosure may be configured to control processor 1502. For example, one or more of the modules or blocks or operations and so on may include but are not limited to, for example, a message routing system, a message router, an OCPP router, a sub router, and so on. At least some of these blocks or modules may be stored on storage device 1510 and loaded into memory 1504 at runtime or may be stored in other computer-readable memory locations.

The term module used herein may refer to a software module, a hardware module, or a module comprising both software and hardware. Generally, software includes computer executable instructions, and possibly also data, and hardware refers to physical computer hardware.

The term ‘data’ generally refers to raw or unorganized facts whereas ‘information’ generally refers to processed or organized data. However, the terms are generally used synonymously herein unless indicated otherwise.

Embodiments and operations according to the present disclosure may be implemented in digital electronic circuitry, and/or in computer software, firmware, and/or hardware, including structures according to this disclosure and their structural equivalents. Embodiments and operations according to the present disclosure may be implemented as one or more computer programs, for example one or more modules of computer program instructions, stored on or in computer storage media for execution by, or to control the operation of, one or more computer processing devices such as a processor. Operations according to the present disclosure may be implemented as operations performed by one or more processing devices on data stored on one or more computer-readable storage devices or media, and/or received from other sources.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not necessarily provided as to whether the embodiments described herein are implemented as a computer software, computer hardware, electronic hardware, or a combination thereof.

In at least some embodiments, one or more aspects or components may be implemented by one or more special-purpose computing devices. The special-purpose computing devices may be any suitable type of computing device, including desktop computers, portable computers, handheld computing devices, networking devices, or any other computing device that comprises hardwired and/or program logic to implement operations and features according to the present disclosure.

Embodiments of the disclosure may be represented as a computer program product stored in a machine-readable medium (also referred to as a computer-readable medium, a processor-readable medium, or a computer usable medium having a computer-readable program code embodied therein). The machine-readable medium may be any suitable tangible, non-transitory medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations may also be stored on the machine-readable medium. The instructions stored on the machine-readable medium may be executed by a processor or other suitable processing device, and may interface with circuitry to perform the described tasks.

The structure, features, accessories, and/or alternatives of embodiments described and/or shown herein, including one or more aspects thereof, are intended to apply generally to all of the teachings of the present disclosure, including to all of the embodiments described and illustrated herein, insofar as they are compatible. Thus, the present disclosure includes embodiments having any combination or permutation of features of embodiments or aspects herein described.

In addition, the steps and the ordering of the steps of methods and data flows described and/or illustrated herein are not meant to be limiting. Methods and data flows comprising different steps, different number of steps, and/or different ordering of steps are also contemplated. Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The embodiments according to the present disclosure are intended to be examples only. Alterations, modifications and variations may be effected to the particular embodiments by those of skill in the art without departing from the scope, which is defined solely by the claims appended hereto.

The terms “a” or “an” are generally used to mean one or more than one. Furthermore, the term “or” is used in a non-exclusive manner, meaning that “A or B” includes “A but not B,” “B but not A,” and “both A and B” unless otherwise indicated. In addition, the terms “first,” “second,” and “third,” and so on, are used only as labels for descriptive purposes, and are not intended to impose numerical requirements or any specific ordering on their objects. Furthermore, the term “exemplary” is used to mean serving as an example and not to mean that something is better or preferred.

1. A system, comprising:
a computer-readable storage medium having executable instructions; and
one or more computer processors configured to execute the instructions to enable a charge point (CP) to communicate with multiple charge point management systems (CPMSs) using an open charge point protocol (OCPP), the instructions to:
establish an OCPP connection between an OCPP router and a CP;
establish an OCPP connection between the OCPP router and a first CPMS;
establish an OCPP connection between the OCPP router and a second CPMS; and
route OCPP messages, by the OCPP router, between the CP and the first CPMS and between the CP and the second CPMS, wherein the routing of OCPP messages is based on stored routing information, the routing information comprising information relating to point to point communication paths between the CP and each of the first and second CPMSs.

2. The system of claim 1, wherein the routing information comprises information relating to an origin or a destination of an OCPP message, wherein the information relating to an origin or a destination is derived from an association between the OCPP message and information relating to the websocket transport layer underlying an OCPP connection over which the OCPP message was communicated.

3. The system of claim 1, wherein the routing information comprises information associating at least one of an OCPP message identifier of an OCPP message, an OCPP transaction identifier of an OCPP message, and an OCPP identification tag of an OCPP message, with an origin of the OCPP message.

4. The system of claim 1, wherein the routing information comprises predefined OCPP message sequencing information according to the OCPP.

5. The system of claim 1, the instructions further to:
route OCPP messages between the CP and the first CPMS to initiate an EV charging session at the CP; and
route OCPP messages between the CP and the second CPMS to configure electrical charging parameters for the EV charging session.

6. The system of claim 1, wherein the routing OCPP messages comprises:
receive an OCPP message with identification tag information from the CP at the OCPP router;
in response to the routing information not having an association between the identification tag information and one of the first and second CPMSs, routing the OCPP message to both the first and second CPMSs;
receive authentication messages from both the first and second CPMSs in relation to the identification tag information;
in response to receiving the authentication messages from both the first and second CPMSs, sending rejection messages to the CP and the first and second CPMSs.

7. The system of claim 1, wherein the instructions are further to:
route OCPP messages, by the OCPP router, between a second CP and each of multiple CPMSs over OCPP connections between the second CP and the OCPP router and between the OCPP router and each of the multiple CPMSs.

8. A method comprising:
at one or more electronic devices having one or more computer processors and computer-readable memory, for enabling a charge point (CP) to communicate with multiple charge point management systems (CPMSs) using an open charge point protocol (OCPP):
establishing an OCPP connection between an OCPP router and a CP;
establishing an OCPP connection between the OCPP router and a first CPMS;
establishing an OCPP connection between the OCPP router and a second CPMS; and
routing OCPP messages, by the OCPP router, between the CP and the first CPMS and between the CP and the second CPMS, wherein the routing of OCPP messages is based on stored routing information, the routing information comprising information relating to point to point communication paths between the CP and each of the first and second CPMSs.

9. The method of claim 8, wherein the routing information comprises information relating to an origin or a destination of an OCPP message, wherein the information relating to an origin or a destination is derived from an association between the OCPP message and information relating to the websocket transport layer underlying an OCPP connection over which the OCPP message was communicated.

10. The method of claim 8, wherein the routing information comprises information associating at least one of an OCPP message identifier of an OCPP message, an OCPP transaction identifier of an OCPP message, and an OCPP identification tag of an OCPP message, with an origin of the OCPP message.

11. The method of claim 8, wherein the routing information comprises predefined OCPP message sequencing information according to the OCPP.

12. The method of claim 8, further comprising:
routing OCPP messages between the CP and the first CPMS to initiate an EV charging session at the CP; and
routing OCPP messages between the CP and the second CPMS to configure electrical charging parameters for the EV charging session.

13. The method of claim 8, wherein the routing OCPP messages comprises:
receiving an OCPP message with identification tag information from the CP at the OCPP router;
in response to the routing information not having an association between the identification tag information and one of the first and second CPMSs, routing the OCPP message to both the first and second CPMSs;
receiving authentication messages from both the first and second CPMSs in relation to the identification tag information;
in response to receiving the authentication messages from both the first and second CPMSs, sending rejection messages to the CP and the first and second CPMSs.

14. The method of claim 8, further comprising:
routing OCPP messages, by the OCPP router, between a second CP and each of multiple CPMSs over OCPP connections between the second CP and the OCPP router and between the OCPP router and each of the multiple CPMSs.

15. A non-transitory computer-readable medium comprising:
computer-readable instructions stored on the computer-readable medium, the instructions for enabling a charge point (CP) to communicate with multiple charge point management systems (CPMSs) using an open charge point protocol (OCPP), the computer-readable instructions to executable by at least one processor to cause the performance of operations comprising:
establishing an OCPP connection between an OCPP router and a CP;
establishing an OCPP connection between the OCPP router and a first CPMS;
establishing an OCPP connection between the OCPP router and a second CPMS; and
routing OCPP messages, by the OCPP router, between the CP and the first CPMS and between the CP and the second CPMS, wherein the routing of OCPP messages is based on stored routing information, the routing information comprising information relating to point to point communication paths between the CP and each of the first and second CPMSs.

16. The non-transitory computer-readable medium of claim 15, wherein the routing information comprises information relating to an origin or a destination of an OCPP message, wherein the information relating to an origin or a destination is derived from an association between the OCPP message and information relating to the websocket transport layer underlying an OCPP connection over which the OCPP message was communicated.

17. The non-transitory computer-readable medium of claim 15, wherein the routing information comprises information associating at least one of an OCPP message identifier of an OCPP message, an OCPP transaction identifier of an OCPP message, and an OCPP identification tag of an OCPP message, with an origin of the OCPP message.

18. The non-transitory computer-readable medium of claim 15, wherein the routing information comprises predefined OCPP message sequencing information according to the OCPP.

19. The non-transitory computer-readable medium of claim 15, the operations further comprising:
routing OCPP messages between the CP and the first CPMS to initiate an EV charging session at the CP; and
routing OCPP messages between the CP and the second CPMS to configure electrical charging parameters for the EV charging session.

20. The non-transitory computer-readable medium of claim 15, the operations further comprising:
routing OCPP messages, by the OCPP router, between a second CP and each of multiple CPMSs over OCPP connections between the second CP and the OCPP router and between the OCPP router and each of the multiple CPMSs.
